(19) United States
(12) Patent Application Publication
(10) Pub. No.: US 2006/0201214 A1
(43) Pub. Date: Sep. 14, 2006

(54) Lock

(76) Inventor: Ulrich Bantle, Empfingen (DE)

Correspondence Address: Pauley Petersen & Erickson, 2800 W Higgins Road, Suite 365, Hoffman Estate, IL, 60195, US

(21) Appl. No.: 10/493,355

(22) PCT Filed: Oct. 16, 2002
(86) PCT No.: PCT/EP02/11562

§ 371 Date: Jan. 18, 2005

(30) Foreign Application Priority Data
Oct. 22, 2001 (DE) 101 51 349.6

(51) Int. Cl. E05B 47/06

(52) U.S. Cl. 70/278.7

(57) ABSTRACT

A lock having a bolt movable between an open position and a closed position by a control element. The control element is associated with a lifting magnet. The magnet locks the control element in closing position with a locking element and moves the locking element to release the closure, from the closed position to the open position. This invention enhances the reliability of the closing process of such a lock while enabling a simple construction. Thus, the lifting magnet is associated with an actuating part, the actuating part comprises a projection which can be actuated by the actuating part and the actuating part releases the lifting magnet from the opening position with the projection.

The invention relates to a lock with a bolt, which can be displaced between an open and a closed position with the aid of an actuator, wherein a solenoid is assigned to the actuator, wherein the solenoid blocks the actuator in the closed position by means of an arresting element, and wherein the solenoid moves the arresting element from the closed into the open position for releasing the locking.

Such a lock is known from DE 299 23 398 U1. Here, the actual locking mechanism has been placed in a lock housing. It comprises an actuator, which has been rotatably seated in the lock housing in the form of an actuating nut. In the manner of a bolt, the actuator drives a locking bolt, which can be moved out of the housing, and/or a push-rod or rotating rod mechanism. In the locked position the actuator can be blocked by means of a solenoid. The latter then positively engages the actuator with an arresting element. The ability of the actuator to rotate is thus prevented. The solenoid must be electrically activated for the renewed release of the actuator.

It is the object of the invention to create a lock of the type mentioned at the outset which operates dependably and is of simple construction.

This object is attained in that an operating element is assigned to the solenoid, that the operating element has a shoulder, which can be actuated by the actuator, and that the operating element moves the solenoid out of the open position by means of the lever.

With this lock design, the operating element takes on at least a portion of the solenoid displacement, so that no electrical energy need to be used for this. This has advantageous effects, in particular with battery-powered locks. Because the actuator displaces the operating element, an unequivocal and dependable lock operation is achieved, wherein the operating element is inevitably triggered.

In accordance with a preferred embodiment of the invention it has been provided that the solenoid has a displaceable armature which supports the arresting element, that the armature is maintained under prestress in the locking or opening position by means of a spring element. In this case the spring element aids the offset of the armature in the locked position if, in the open position, the armature is held under spring prestress. The functional dependability of the lock is further increased by this. However, if the armature is under spring prestress in the locking position, it is possible to use the force which is applied manually via the actuator for cocking the spring. This then reduces the energy required for operating the solenoid.

In addition it can also be provided that the armature is maintained in the open and/or the closed position by means of a permanent magnet assigned to the solenoid.

In that case the armature is definitely fixed in its extreme positions.

In accordance with a conceivable alternative of the invention it can be provided that the shoulder of the operating element runs up on a sliding flank of the actuator in the course of the transition of the actuator from the closed position into the open position, that a lever can be operated by means of the shoulder, and that the lever moves the armature of the solenoid out of the open position. The lever can be laid out in such a way that the offset of the shoulder is geared down in such a way that the solenoid, or its armature, is forcibly displaced over a desired path. This can then be used in such a way that the shoulder is mechanically controlled via the lever from the open position as far as the closed position. In the process it can be provided in particular that the shoulder is supported by a lever arm, that the lever arm, as well as the lever, is coupled to a pivot bearing, and that the actuator is rotatably seated in the lock housing.

A lock in accordance with the invention can be distinguished in that the operating element is maintained in a restoring position assigned to the open and closed position of the actuator by means of a restoring spring, that in the course of the transition from the open position into the closed position the actuator displaces the operating element on the shoulder against the spring force of the restoring spring, that, for being reset in the restoring position, the actuator releases the operating element into the closed position. The restoring spring assures that the operating element is always returned into its initial position, from which it can be displaced in a reproducible manner.

For reducing the outlay of parts it can be provided here that the operating element is embodied as a plastic injection- molded part with the restoring spring formed on it in one piece.

The invention will be explained in greater detail in what follows by means of an exemplary embodiment represented in the drawings. Shown are in:

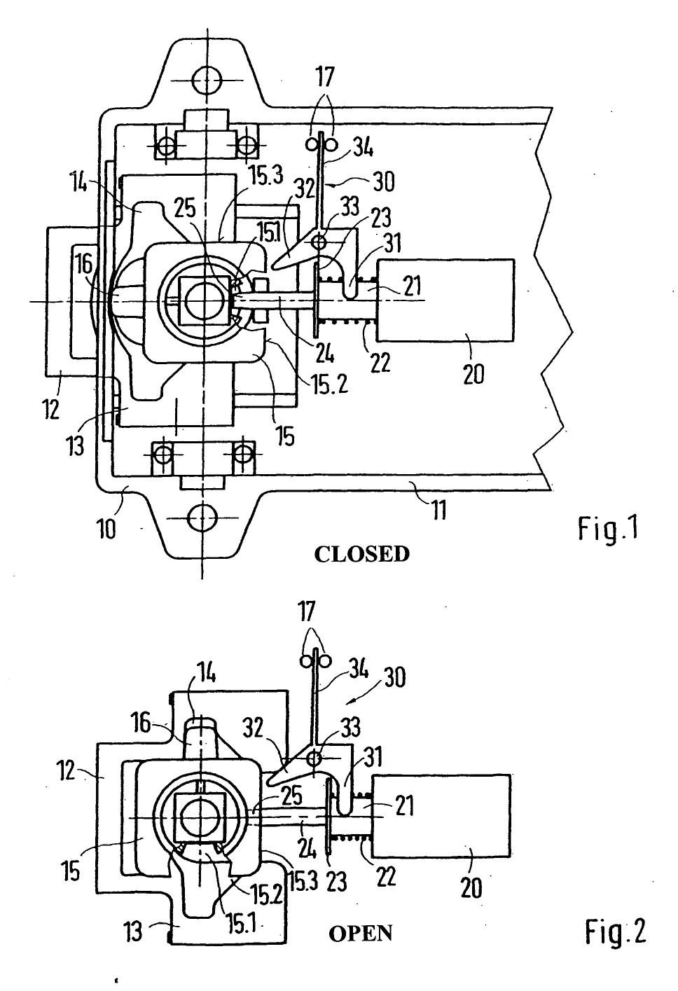

FIG. 1, a view from above on a lock with a lock housing and a locking mechanism arranged therein,

FIG. 2, the locking mechanism in accordance with FIG. 1 in a separate representation,

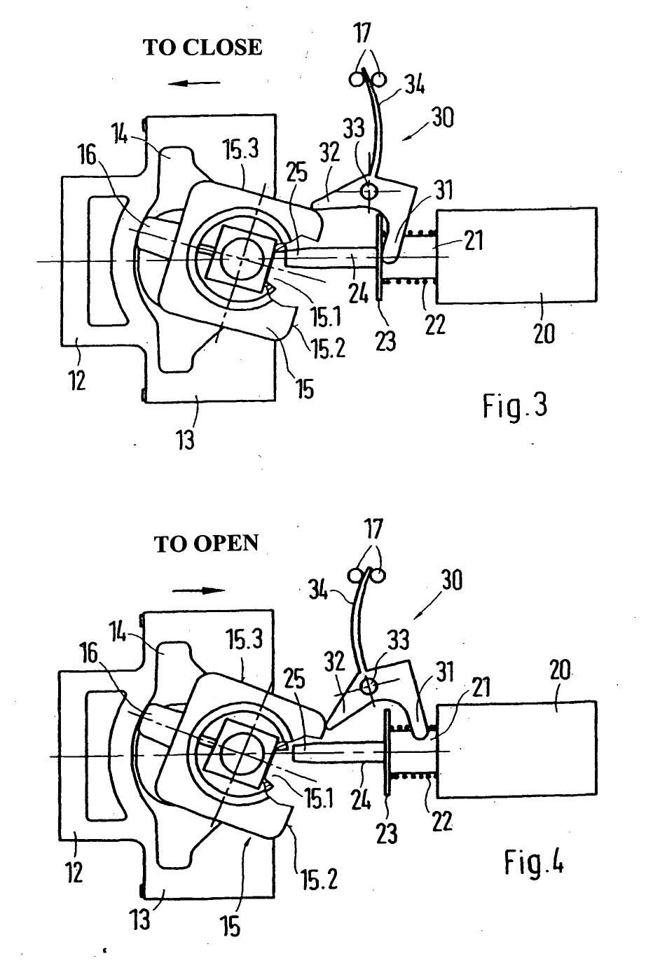

FIG. 3, the locking mechanism in accordance with FIG. 2 during the transition from the open into the closed position, and

FIG. 4, the locking mechanism in accordance with FIG. 2 during the transition from the closed into the open position.

A lock 1 with a lock housing 10 is represented in FIG. 1. A shoulder housing 11 has been formed laterally on the lock housing 10 in one piece with it. A locking mechanism is housed in the lock housing 10, or shoulder housing 11, whose details can be found in FIG. 2.

As FIG. 2 shows, the locking mechanism has a bolt 12, which can be moved back and forth between an open and a closed position by means of an actuator 15. For being displaced, one end of the bolt 10 is fastened to a locking element 13. The locking element 13 has a control cam 14. The actuator 15 is guided by means of an eccentric device 16 along the control cam 14. The eccentric device 16 is connected in one piece and rigidly with the actuator. The actuator 15 is rotatably seated in the lock housing 10. In this case it can be rotated around an axis of rotation extending perpendicularly in respect to the drawing axis. As can be seen in FIG. 3, the eccentric device 16 pushes the locking element out of the open into the closed position when the actuator is displaced. The completely extended position of the bolt 12, and therefore the closed position of the lock, is represented in FIG. 1. For getting back into the open position from this locked position it is necessary to rotate the actuator in a clockwise direction, as shown in FIG. 4. In the course of this the eccentric device 16 slides up on a rear flank 15.3 of the control cam 14 and pulls the bolt 12 into the housing.

A solenoid 20 is used for being able to effect a secure arrestment of the lock in the closed position. It is operated electrically and is supplied by a current source not shown in the drawings. Preferably the current source is a battery placed into the lock housing 10. The solenoid 20 has an armature 21, which can be displaced from a locking into an open position by means of the solenoid. A blocking disk 23 has been pulled onto the armature. The blocking disk 23 supports a spring element 22. The spring element 22 is supported on the housing of the solenoid on the side facing away from the blocking disk 23. The armature 21 has a pin 24 protruding in the direction toward the actuator 15. As can be seen in FIG. 4, the actuator has a receiver 15.1, into which the pin 24 can be inserted with an arresting element 25. In this case the receiver 15.1 is embodied in such a way that, when the arresting element has been inserted, the rotation of the actuator 15 is positively prevented.

An operating element 30 is arranged on a pivot bearing 33. In this case the operating element 30 is embodied as a plastic injection-molded element with a restoring spring 34 formed on it. The restoring spring is maintained in a seat 17 of the lock housing 10. Starting at the pivot bearing 33, the operating element has a lever 31 protruding in the direction toward the solenoid 20, as well as a shoulder 32 oriented in the direction toward the actuator 15. The restoring spring 34 maintains the operating element 30 in the restoring position represented in FIG. 1.

The mode of operation of the lock will be addressed in greater detail in what follows.

Starting from the open position of the lock represented in FIG. 2, the actuator 15 can be turned in a counterclockwise direction. Turning can be accomplished, for example, by means of a knob or a key. In the course of the turning of the actuator, the shoulder 32 of the operating element 30 slides up on a flank 15.3 of the actuator 15, as clearly shown in FIG. 3. The operating element 30 is deflected by this and the lever 31 comes into contact with the blocking disk 23 of the armature 21. In the open position represented in FIG. 2, the armature 21 is maintained on a permanent magnet inside the housing of the solenoid 20. The lever 31 now disengages the armature 21 from the permanent magnet. By means of this and with the aid of the spring element 22, the armature 21 can be pushed forward in the direction toward the actuator 15. In the course of continued rotation of the actuator 15, the receiver 15.1 comes into operative contact with the arresting element 25 of the armature 21. In this case the lever 31 has been laid out in such a way that a compulsory guidance of the armature 21 into the receiver 14.1 is performed. This increases the operational dependability of the lock. After the actuator 15 has been introduced into the locking position, the arresting element 25 blocks the lock in such a way that it cannot be inadvertently opened. The operating element 30 snaps into its restoring position under the effect of the restoring spring 34. Opening the lock becomes possible if an electrical pulse is imparted to the solenoid. This electrical pulse can be generated from an input keyboard, for example. The user must enter an approved code for this purpose. Thereafter, current is switched to the solenoid, because of which the armature 21 is moved into its open position (see FIG. 2). In the open position the armature 21 is held against the permanent magnet which is integrated into the solenoid 20. Therefore the voltage can be disconnected from the solenoid 20 and this current can be released.

After the solenoid 20, and therefore the armature 21, was moved into the open position, the actuator 15 can be rotated back in a clockwise direction. In the process the operating element 30 is passively deflected on a sliding surface 15.2 until the shoulder 32 has moved past the transition area between the sliding surface 15.2 and the flank 15.3. Then the operating element 30 again snaps into its restoring position. As a result of the rotation of the actuator 15, the bolt 12 can be retracted into the lock housing 10. With this, the lock is available for a further locking operation.

1. A lock with a bolt (12), displaceable between an open position and a closed position using an actuator (15), wherein a solenoid (20) is assigned to the actuator (15), the solenoid (20) blocks the actuator (15) in the closed position with an arresting element (25), and the solenoid (20) moves the arresting element (25) from the closed position into the open position for releasing a locking state, the lock comprising:
an operating element (30) assigned to the solenoid (20),
the operating element (30) having a shoulder (32), actuated by the actuator (15), and
the operating element (30) moves moving the solenoid (20) out of the open position using the lever (31).

2. The lock in accordance with claim 1, wherein the solenoid (20) has a displaceable armature (21) supporting the arresting element (25), and the armature (21) is maintained under a prestress condition in the closed position or the open position by a spring element (22).

3. The lock in accordance with claim 2, wherein the armature (21) is maintained in the open position or the closed position by a permanent magnet assigned to the solenoid (20).

4. The lock in accordance with claim 3, wherein the shoulder (32) of the operating element (30) runs up on a sliding flank (15.3) of the actuator (15) during a transition of the actuator (15) from the closed position into the open position, a lever (31) is operable by the shoulder (32), and the lever (31) moves the armature (21) of the solenoid (20) out of the open position.

5. The lock in accordance with claim 4, wherein the shoulder (32) is supported by a lever arm, the lever arm and the lever (31) are coupled to a pivot bearing (33), and the actuator (15) is rotatably seated in the lock housing (10).

6. The lock in accordance with claim 5, wherein the operating element (30) is maintained in a restoring position assigned to the open position and the closed position of the actuator (15) by a restoring spring (34), during the transition from the open position into the closed position the actuator (15) displaces the operating element (30) on the shoulder (32) against a spring force of the restoring spring (34), and for resetting in the restoring position the actuator (15) releases the operating element (30) into the closed position.

7. The lock in accordance with claim 6, wherein the operating element (30) is a plastic injection molded part integrated with the restoring spring (34).

8. The lock in accordance with claim 1, wherein the shoulder (32) of the operating element (30) runs up on a sliding flank (15.3) of the actuator (15) during a transition of the actuator (15) from the closed position into the open position, a lever (31) is operable by the shoulder (32), and the lever (31) moves the armature (21) of the solenoid (20) out of the open position.

9. The lock in accordance with claim 8, wherein the shoulder (32) is supported by a lever arm, the lever arm and the lever (31) are coupled to a pivot bearing (33), and the actuator (15) is rotatably seated in the lock housing (10).

10. The lock in accordance with claim 1, wherein the operating element (30) is maintained in a restoring position assigned to the open position and the closed position of the actuator (15) by a restoring spring (34), during a transition from the open position into the closed position the actuator (15) displaces the operating element (30) on the shoulder (32) against a spring force of the restoring spring (34), and for resetting in the restoring position the actuator (15) releases the operating element (30) into the closed position.

11. The lock in accordance with claim 10, wherein the operating element (30) is a plastic injection molded part integrated with the restoring spring (34).
